(19) United States
(12) Patent Application Publication
(10) Pub. No.: US 2009/0257931 A1
(43) Pub. Date: Oct. 15, 2009

(54) METHOD OF RECOVERING NOBLE METALS AND RECOVERING SYSTEM FOR NOBLE METALS

(76) Inventors: Yoshihiko Nakano, Yokohama-shi (JP); Jun Tamura, Yokohama-shi (JP); Kazuhiro Yasuda, Yokohama-shi (JP); Mutsuki Yamazaki, Yokohama-shi (JP); Itsuko Mizutani, Yokohama-shi (JP); Yoshiko Hiraoka, Kawasaki-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/490,563

(22) Filed: Jun. 24, 2009

Related U.S. Application Data
(63) Continuation of application No. PCT/JP2009/051150, filed on Jan. 20, 2009.

(30) Foreign Application Priority Data
Jan. 12, 2008 (JP) 2008-010339
Nov. 21, 2008 (JP) 2008-298624

(51) Int. Cl. C01G 55/00

(52) U.S. Cl. 423/22

(57) ABSTRACT

A recovering method is provided, which includes contacting a solid component containing Ru with an aqueous solution to create a Ru compound, and causing the Ru compound to selectively elute in the aqueous solution. The aqueous solution is formed of at least one selected from the group consisting of aqueous solutions A, B, C, D, and E. The aqueous solution A comprises an acid and formic acid, alcohols, aldehydes, a compound having a hemiacetal structure or a compound having an acetal structure. The aqueous solution B comprises an acid and a compound which creates, in the coexistence thereof with the acid, formic acid, alcohols, aldehydes, a compound having a hemiacetal structure or a compound having an acetal structure. The aqueous solution C comprises an acid and sugars. The aqueous solution D comprises formic acid, and the aqueous solution E comprises oxalic acid.

### CROSS REFERENCE TO RELATED APPLICATIONS

This is a Continuation application of PCT Application No. PCT/JP2009/051150, filed Jan. 20, 2009, which was published under PCT Article 21(2) in English.

This application is based upon and claims the benefit of priority from prior Japanese Patent Applications No. 2008-010339, filed Jan. 21, 2008; and No. 2008-298624, filed Nov. 21, 2008, the entire contents of both of which are incorporated herein by reference.

### BACKGROUND OF THE INVENTION

1. Field of the Invention

This invention relates to a method of selectively recovering Ru compounds from a solid component containing Ru and to a recovering system for Ru compounds.

2. Description of the Related Art

Conventionally, Ru (ruthenium) has been used in large quantities as an insoluble electrode in electrolytic soda processing industries. Recently, the usage of Ru as an anode catalyst PtRu, i.e. as a catalyst for a fuel cell, or as a hard disk component has been sharply increased. The demands for Ru are expected to be further increased in future. At present, many studies are intensively made on the development of a direct methanol type fuel cell (DMFC) to be used as a fuel cell for mobile equipments. Ru is an indispensable metallic element for use as an anode catalyst for the DMFC. Even though the deposits of Ru are more limited in quantity than that of Pt, the recover of Ru is not conducted at present because of high recovering cost. However, the demands for the recovering of Ru are expected to be increased in future.

Conventionally, the recovering of noble metals contained in a solid component has been performed by the elution of noble metals using an oxidizing acid such as aqua regia, etc. The anode catalyst for a fuel cell is constituted not only by Ru but also by other noble metals. When an oxidizing acid is employed in the recovering of noble metals, all kinds of the noble metals elute, thereby making it impossible to electively recover Ru. Therefore, additional separating/recovering steps are required for the recover of Ru. Meanwhile, according to the recover of Ru by a combustive oxidation method, it is possible, through distilling separation by gasification, to separate non-volatile platinum oxide from highly volatile materials such as RuO₄, OsO₄, etc. However, this combustive oxidation method is accompanied with problems such as recovering ratios of RuO₄.

JP-A 2005-289001 (KOKAI) describes a method of recovering noble metal catalysts and electrolytic polymers from the membrane-electrode assembly (MEA) of spent fuel cell, wherein the noble metal catalysts and electrolytic polymers are eluted by aqua regia and then separatively recovered. According to this recovering method, since noble metals are recovered by elution using aqua regia and by combustive oxidation, it is required to overcome the aforementioned problems.

### BRIEF SUMMARY OF THE INVENTION

A recovering method according to one aspect of the present invention comprises:

contacting a solid component containing Ru with an aqueous solution to create a Ru compound, the aqueous solution being formed of at least one selected from the group consisting of an aqueous solution A comprising an acid and formic acid, alcohols, aldehydes, a compound having a hemiacetal structure or a compound having an acetal structure, an aqueous solution B comprising an acid and a compound which creates, in the coexistence thereof with the acid, formic acid, alcohols, aldehydes, a compound having a hemiacetal structure or a compound having an acetal structure, an aqueous solution C comprising an acid and sugars, an aqueous solution D comprising formic acid, and an aqueous solution E comprising oxalic acid; and

selectively eluting the Ru compound in the aqueous solution.

A recovering system according to another aspect of the present invention is equipped with a tank for accommodating a solid component containing Ru and an aqueous solution which is designed to be contacted with the solid component and capable of eluting Ru;

wherein the aqueous solution is formed of at least one selected from the group consisting of an aqueous solution A comprising an acid and formic acid, alcohols, aldehydes, a compound having a hemiacetal structure or a compound having an acetal structure, an aqueous solution B comprising an acid and a compound which creates, in the coexistence thereof with the acid, formic acid, alcohols, aldehydes, a compound having a hemiacetal structure or a compound having an acetal structure, an aqueous solution C comprising an acid and sugars, an aqueous solution D comprising formic acid, and an aqueous solution E comprising oxalic acid; and

the system is designed to be executed by a first step of contacting the solid component containing Ru with the aqueous solution to create a Ru compound, and a second step of causing the Ru compound to selectively elute in the aqueous solution.

### BRIEF DESCRIPTION OF THE SEVERAL VIEWS OF THE DRAWING

FIG. 1 is a conceptual diagram illustrating the process flow of a recovering method according to one embodiment; and

FIG. 2 is a diagram illustrating an embodiment of the noble metal-recovering system according to one embodiment.

### DETAILED DESCRIPTION OF THE INVENTION

Next, the noble metal-recovering method according to one embodiment will be explained with reference to drawings.

(Solid Components Containing Ru)

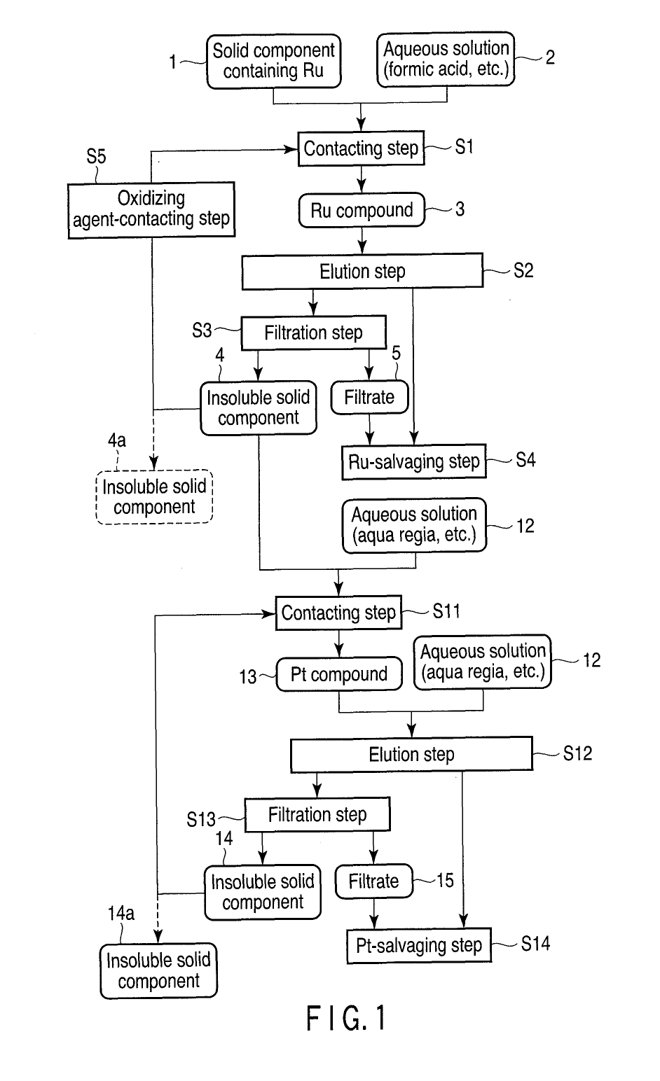

In the process flow of a recovering method according to one embodiment as shown in the conceptual diagram of FIG. 1, a solid component 1 containing Ru may be a catalytic component such as a catalyst for a fuel cell (anode catalyst) wherein a PtRu alloy is contained as a major component or may be a component for a recording medium such as a hard disk, e.g. an information recording medium. Namely, there is not any particular limitation with regard to the solid component 1 as long as the solid component contains Ru.

The solid component 1 containing Ru is preferably formed of a solid component which has been treated mainly by aqua regia and which further contains a noble metal exhibiting a higher oxidation-reduction potential than that of hydrogen. Specific examples of such a noble metal include Au (gold), Ag (silver), Pt (platinum), Rh (rhodium), Ir (iridium), Ru (ruthenium), Os (osmium), etc. Among these noble metals, a noble metal exhibiting a higher oxidation-reduction potential than that of Ru such as Pt is more preferable.

The solid component 1 containing Ru, etc. is preferably constituted mainly by noble metals if possible such as those which are formed of only an anode catalyst or a hard disk, or formed of a combination thereof with a composition which is insoluble to an acid such as a solid component including carbon or Teflon (trademark) for example. However, the solid component 1 may not be limited to those described above but may contain a solid component containing other kinds of base metals.

(Aqueous Solution for Elution)

As the aqueous solution for elution, at least one selected from the following aqueous solutions can be employed.

(Groups of Aqueous Solutions)

An aqueous solution A comprising an acid and formic acid, alcohols, aldehydes, a compound having a hemiacetal structure or a compound having an acetal structure;

An aqueous solution B comprising an acid and a compound which creates, in the coexistence thereof with the acid, formic acid, alcohols, aldehydes, a compound having a hemiacetal structure or a compound having an acetal structure;

An aqueous solution C comprising an acid and sugars;

An aqueous solution D comprising formic acid; and

An aqueous solution E comprising oxalic acid.

More specifically, it is possible, as an aqueous solution 2, to employ an aqueous solution containing an acid (acidic material), and a reducing material (reductant). As the acidic material, it is possible to employ sulfuric acid, hydrochloric acid, nitric acid, carboxylic acid, an organic acid, etc. As the reducing material, it is possible to employ formic acid, alcohols, aldehydes, a compound having a hemiacetal structure, a compound having an acetal structure, etc. The aqueous solution 2 may be formulated by optionally selecting an acidic material and a reducing material from these acidic and reducing materials described above (the aqueous solution A).

Instead of using formic acid, alcohols, aldehydes, a compound having a hemiacetal structure or a compound having an acetal structure, it is also possible to employ sugars having reduction properties. The aqueous solution 2 may be formulated by optionally selecting sugar and an acidic material from the acidic materials described above (the aqueous solution C).

By the term “reducing material”, it is intended to mean, in a wide sense, a material which changes into a reducing material as it is coexisted with an acid. For example, it is possible to employ, as such a reducing material, alcohols and a compound having a hemiacetal structure or an acetal structure such as sugars. The aqueous solution 2 may be formulated by optionally selecting an acidic material and a reducing material from the materials described above (the aqueous solution B).

Formic acid and oxalic acid are provided not only with the function of acidic material but also with the function of reducing material. Because of this, these acids can be used singly as the aqueous solution 2 (the aqueous solutions D and E).

Aqueous solutions containing an acidic material and a reducing material selected from the materials described above, or aqueous solutions containing formic acid or oxalic acid, namely, at least one selected from the group consisting of the aforementioned various aqueous solutions are defined herein as “aqueous solution(s) for eluting Ru”.

As examples of alcohols, it is preferable to employ primary alcohol which generates aldehyde group under acidic environments and hence methanol, etc. can be employed. There is not any particular limitation with respect to other kinds of alcohols as long as they are soluble in water. More specifically, it is possible to employ ethanol, ethylene glycol, glycerin, 1-propanol, etc.

As examples of aldehydes, it is possible to employ formaldehyde and acetaldehyde. It is also possible to employ other kinds of materials such as, though not limited thereto, hydroxyaldehyde, glyoxal, oxoacetic acid, etc.

With respect to examples of acidic materials, they include sulfuric acid, hydrochloric acid, nitric acid, carboxylic acid, and organic acids. As for the carboxylic acid, it is possible to employ formic acid, oxalic acid and acetic acid. As for other kinds of carboxylic acid, they may not be limited to those which can be dissolved in water. More specifically, it is possible to employ propionic acid, butyric acid, 2-methoxy acetic acid, 2-ethoxy acetic acid, etc. Other than carboxylic acid, examples of representative organic acids include acids having a sulfonic acid group, hydroxy acid group, thiolic acid group or enolic acid group. In a fuel cell, Nafion (trademark) which is a representative acid having sulfonic acid group is generally employed. This Nafion is also useful as an acid. In the case where Ru is desired to be recovered from Pt—Ru alloys, it is preferable to use, other than hydrochloric acid, an acid which is more suited for selectively eluting Ru. Because, when hydrochloric acid is used, platinic chloride generates, thereby increasing the elution of platinum.

As examples of the compound having a hemiacetal structure or an acetal structure, it is possible to use sugars. Among them, aldose having aldehyde group is more preferable for use. In this case, it may be monosaccharide or polysaccharide. In viewpoint of Ru recovering efficiency (quantity of recovered Ru/quantity of sugar), monosaccharide which is relatively small in molecular weight is more preferable for use. Specific examples of the monosaccharide include triose, tetrose, pentose, hexose and heptose. Representative examples of hexose include glucose, galactose, fructose, etc. Other kinds of sugars include disaccharide such as maltose, sucrose, etc. Although sucrose is not reductive by itself, it can be decomposed into glucose and fructose as it is dissolved in an aqueous solution of an acid (for example, an aqueous solution of sulfuric acid), thereby enabling the sucrose to exhibit reducing properties. Thus, sucrose can be applied to the Ru-eluting aqueous solution 2 as one of the compounds which generate formic acid, alcohols, aldehydes, a compound having a hemiacetal structure or a compound having an acetal structure.

In the Ru-eluting aqueous solution 2, the concentration of an acid in the aqueous solution thereof, excluding that of formic acid and oxalic acid, is preferably confined to 1-90 wt %. When this concentration is lower than 1 wt %, the rate of elution may become too slow. When this concentration is higher than 90 wt %, the effects of electrolytic dissociation would be deteriorated due to low water content, thereby diminishing the effects of eluting Ru. Further, in the case of an additive which can be turned into a reducing material through the decomposition reaction thereof in an aqueous solution of an acid such as primary alcohol or sucrose for example, it would be impossible to sufficiently generate a reducing material as the concentration of an acid is too low. Therefore, the concentration of an acid in the aqueous solution thereof is preferably not lower than 10 wt %, more preferably not lower than 30 wt %.

In the case of using the Ru-eluting aqueous solution 2 wherein a reducing material is contained together with any one of the aforementioned acids, a reducing material or a material which generates a reducing material is incorporated in the aqueous solution 2. The reducing material or the material which generates a reducing material may be selected, for example, from (I) alcohols, (II) aldehydes, (III) a material having a hemiacetal structure and (IV) a compound having an acetal structure. Herein all of the compounds of (I) through (IV) are put together as a group “X” and a total weight thereof is defined as “x” (wt %). Further, the concentration of the acid and the water are defined as “y” (wt %) and “z” (wt %).

Then, the range of “x” is 0.5≦x≦40 and the range of “y” is 1≦y≦50. When the values of “x” and “y” are lower than the aforementioned lower limits, respectively, the elution rate of Ru would become too slow. When the values of “x” and “y” are higher than the aforementioned upper limits, respectively, the effects of eluting Ru may be deteriorated. On the other hand, in the case of “z”, on the contrary to “x” and “y”, when the value of “z” is lower than the lower limit, the effects of eluting Ru may be deteriorated and when the value of “z” is higher than the upper limit, the elution rate of Ru would become too slow. The value of “z” may be the balance of x+y and the range of “z” is confined to 10≦z≦98.5. Namely, the value of “z” is preferably suitably selected depending on the kind of the acid and on the degree of electrolytic dissociation.

In the case where formic acid or oxalic acid is employed as the Ru-eluting aqueous solution 2, there is no need to additionally incorporate additives, since any of these formic acid and oxalic acid exhibits, by itself, acidity and reducing properties. The content of formic acid or oxalic acid is preferably confined to 0.1-90 wt %. When this content is lower than 0.1 wt %, the Ru-recovering ratio would become too low and hence inefficient. When this content is higher than 90 wt %, the effects of electrolytic dissociation would be deteriorated due to decreased water content, thereby undesirably diminishing the effects of eluting Ru. Since formic acid is smaller in molecular weight as compared with oxalic acid, formic acid is more excellent in efficiency as compared with oxalic acid in terms of the recovering quantity of Ru based on the same added quantity of these acids. Incidentally, it is also possible to employ the aforementioned reducing materials or additives which generate the aforementioned reducing materials, such as alcohols, aldehydes, a compound having a hemiacetal structure or a compound having an acetal structure.

These reducing materials or additives may be high-purity grade reagents or ordinary reagents or industrial chemicals.

Incidentally, when an Ru-eluting aqueous solution 2 containing sulfuric acid is employed, the ratio of eluting base metals is small. Moreover, in the case where the recovering of Ru is performed electrochemically as described hereinafter, it is possible, in the employment of this Ru-eluting aqueous solution 2, to minimize the evaporation of gaseous components which are electrochemically decomposed on the occasion of electrolysis from the aqueous solution as compared with other kinds of inorganic acids such as hydrochloric acid, nitric acid, etc. For this reason, the Ru-eluting aqueous solution 2 containing sulfuric acid is easier in the controlling thereof.

(Contacting Step: S1)

In order to enable a solid component 1 containing Ru to contact with the Ru-eluting aqueous solution 2, the Ru-eluting aqueous solution 2 is poured into a vessel and then the solid component 1 containing Ru is dipped in the Ru-eluting aqueous solution 2.

In order to enable a solid component 1 to effectively contact with the Ru-eluting aqueous solution 2, it is advisable to preliminarily cut or pulverize the solid component 1 containing Ru. In order to accelerate the elution rate of Ru, the elution of Ru may be performed under heating and/or pressurization. The heating may be performed using a heater. Further, if it is desired to employ pressurization together with heating, the employment of autoclave may be effective in reducing the elution time. Further, the employment of stirring together with heating or pressurization may be effective.

The elution of Ru compounds may be promoted by creating a potential difference on the solid component 1 containing Ru in applying a voltage to the solid component 1 in such a manner that the surface oxidation of Pt can be often caused to occur. By this method, the contact between the solid component 1 and the Ru-eluting aqueous solution 2 can be accelerated. When it is desired to recover Ru and Pt from a membrane-electrode assembly (MEA) such as a fuel cell, alcohol and MEA are placed in an autoclave and heated at a temperature of not lower than 200° C. to dissolve the catalyst layer thereof. Then, the Ru-eluting aqueous solution is added to the alcohol, thereby eluting Ru compounds.

(Eluting Step: S2)

Although the Ru contained in the anode catalyst for use in a fuel cell is originally in a state of Ru—Pt alloy, part of the alloy is separated into Ru metal and Pt metal with time during the usage thereof. Further, it is assumed that some portion of the alloy may be possibly turned into Ru oxide.

When the solid component 1 containing Ru and turned into various states as described above is contacted with the Ru-eluting aqueous solution 2, Ru is assumably turned into a Ru compound 3 which can be easily eluted into the Ru-eluting aqueous solution 2. Although the structure of the Ru compound 3 is not yet made clear, it is assumed that the structure of the Ru compound 3 differs depending on the hysteresis and treating conditions of the solid component 1 containing Ru. For example, part of the Ru compound 3 is conceivably turned into Ru complex ion.

The Ru compound 3 can be selectively eluted into the Ru-eluting aqueous solution 2. A portion of Pt, etc. is conceivably turned into compounds. It is possible to observe the Ru compound 3 that has been selectively eluted in a great amount.

(Recovering Step: S4)

The Ru-eluting aqueous solution 2 into which the Ru compound 3 has been selectively eluted as described above is then treated according to the following method to recover Ru as a solid state.

By reducing the Ru compound 3 at nearly the reduction potential thereof by an electrolytic reduction method, it is possible to selectively recover high-purity Ru. Since base metals cannot be reduced in view of electric potential, it is possible to recover high-purity Ru even if base metals are mixingly existed in the Ru-eluting aqueous solution 2. The Ru-eluting aqueous solution 2 that has been once used for recovering Ru can be re-used by suitably replenishing a consumed quantity of chemicals of the X group that have been consumed for eluting Ru. As a result, it is possible to reduce the discharge of waste liquid.

The aqueous solution into which Ru has been selectively eluted is then contacted with an adsorbent carrying a chelate such as EDTA (Ethylene Diamine Tetraacetic Acid), thereby making it possible to electively recover Ru.

The Ru-eluting aqueous solution 2 into which Ru has been selectively eluted is separated from insoluble solid component 4 (residue) by filtration and the filtrate 5 is recovered. This filtrate 5 is then heated to evaporate liquid components to recover a solid matter which is then dried out to obtain Ru (corresponding to S4 of FIG. 1). Alternatively, the pH of the liquid component of filtrate 5 may be adjusted to 7 or more to re-precipitate the Ru compound which is then subjected to evaporation/drying processes to recover Ru. Further, a mixture containing organic materials and the Ru compound and obtained from the evaporation/drying processes may be heat-treated in a reducing atmosphere to recover Ru metal. As described above, Ru can be separated as a metal by removing organic materials.

The insoluble solid component 4 that has been obtained from the repeated treatment of the aforementioned contacting step (S1), eluting step (S2) and filtrating step (S3) and contains almost no Ru may occasionally contain noble metals such as Pt. These noble metals can be recovered by further executing the following steps.

(Oxidizing Agent-Contacting Step: S5)

When it is desired to repeatedly elute Ru, the residue (insoluble solid component 4) of the solid component 1 containing Ru is preferably contacted with an oxidizing agent (S5). As the oxidizing agent, it is possible to employ air, oxygen, ozone or hydrogen peroxide. By contacting the residue of the solid component 1 with any one of these oxidizing agents and by removing liquid (Ru-eluting aqueous solution) from the solid component 1 containing Ru, it becomes possible to additionally elute the Ru that has been contained in the solid component 1 but could not be eluted completely in the first one step of selectively eluting the Ru compound. Although the reason is not yet made clear, it is assumed that when the organic materials adsorbed on the surface of the solid component containing Ru are removed using an oxidizing agent, it is possible to promote the dissolution of Ru again.

(Pt-Recovering Step: S11-14)

After the elution of Ru from the solid component 1 containing Ru is repeated so as to create a state where almost no Ru is contained in the solid component 1 as described above, the solid component 1 is subjected to the following steps provided that the insoluble solid component 4 still contains a noble metal such as Pt. The insoluble solid components 4 is burnt to remove organic materials and then the resultant material is contacted with an aqueous solution such as aqua regia to turn the Pt into a Pt compound 13 (S11). Then, the Pt compound 13 is caused to elute into this aqueous solution (S12).

The eluate containing the Pt compound 13 is then subjected to filtration (S13) to separate the Pt compound 13 from the insoluble solid component 14 (residue), thereby recovering a filtrate 15. From this filtrate, Pt can be recovered as a solid material. In this recover of Pt, the electrolytic reduction method described in connection with the recovering of Ru can be employed (S14). In this case, even if a trace amount of Ru or base metals are contained in the filtrate, it is possible to recover high-purity Pt since the reduction potential of Pt is relatively high. Alternatively, it is also possible to employ known methods such as a method wherein the insoluble solid components 4 is burnt to remove organic materials and then the resultant material is fused in an electric furnace to electrolytically recover Pt.

(Recovering System)

The noble metal-recovering system according to one embodiment is characterized in that it is equipped with a tank for accommodating a solid component 1 containing Ru and an aqueous solution 2 which is designed to be contacted with the solid component and capable of eluting Ru, and that it includes a first step of contacting the solid component with the aqueous solution to form a Ru compound 3 (Contacting step: S1), and a second step of causing the Ru compound 3 to selectively elute in the aqueous solution 2 (Eluting step: S2).

In the first step (S1), a solid component 1 containing Ru is enabled to contact with the aqueous solution 2, thereby creating the Ru compound 3. In the second step (S2), the Ru compound 3 that has been formed in the first step (S1) is enabled to selectively elute in the aqueous solution 2. The system comprising a combination of these steps is enabled to exhibit excellent effects that cannot be found in the prior art in the respect that Ru is enabled to selectively elute from the solid component 1 containing Ru.

Further, a third step of recovering Ru as a solid matter (Recovering step: S4) may be provided subsequent to the second step (S2). The noble metal-recovering system provided with the third step may be performed in separate steps using a couple of apparatuses or may be sequentially performed in two steps using one apparatus.

As one example of using a couple of apparatuses, the system may be performed in such a manner that the selective elution of Ru is performed using a single apparatus and then the supernatant obtained is transferred to another apparatus to recover Ru. As one example of sequentially performing two steps using only one apparatus, the system may be performed in such a manner that while executing the selective elution of Ru in one apparatus, the selective reduction of Ru is performed at nearly the Ru-reduction potential by an electrolytic reduction method, thereby recovering the Ru. Of course, the construction of the system is not limited to the aforementioned examples. For example, as described above, it is possible to precipitate Ru as a metal through the pH-adjusting operation wherein the aqueous solution is turned into alkaline solution or through the organic material-removing operation wherein alcohols added are removed.

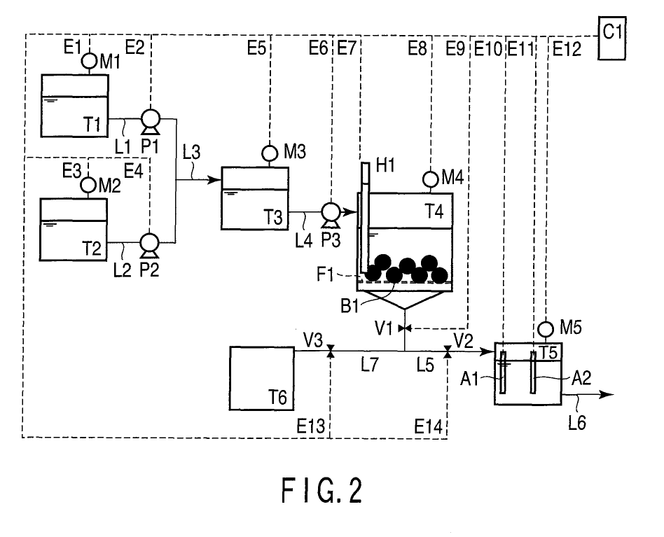

In the noble metal-recovering system according to one embodiment, which is shown as a schematic diagram in FIG. 2, T1 and T2 represent respectively a chemical liquid tank, T3 represents a mixing tank, T4 represents an Ru elution tank, T5 represents an Ru-recovering tank, L1 through L6 represent respectively a pipeline, M1 through M5 represent respectively a monitoring device, E1 through E14 represent respectively a signal line, P1 through P3 represent respectively a pump, F1 represents a filter, S1 represents a solid component containing Ru, V1 through V3 represent respectively a valve, C1 represents a controlling unit, and A1 and A2 represent respectively an electrode plate.

(Preparation of Chemical Liquid)

In the noble metal-recovering system according to one embodiment, it is possible to use an aqueous solution containing formic acid. An aqueous solution containing formic acid at a high concentration can be accommodated in the chemical liquid tank T1. From this chemical liquid tank T1, the aqueous solution containing formic acid at a high concentration is fed to the mixing tank T3 through the pipelines L1 and L3 by the pump P1.

Pure water can be accommodated in the chemical liquid tank T2. From this chemical liquid tank T2, pure water is fed to the mixing tank T3 through the pipelines L2 and L3 by the pump P2.

Using the monitoring device M3, the concentration and the quantity of the aqueous solution containing formic acid and accommodated in the mixing tank T3 is controlled. More specifically, the information regarding the pH, temperature and liquid quantity of the mixing tank T3 is obtained from the monitoring device M3. A pH meter can be employed for measuring the pH. A thermocouple can be employed for measuring the temperature. A level gauge can be employed for measuring the liquid quantity. These information can be transmitted, via the signal line E5, to the control section C1.

In the interior of the control section C1, these information is compared with the values of data base which have been stored therein in advance. When it is found from this comparison that a predetermined concentration and a predetermined liquid quantity have been already reached, the information thereof is transmitted, via the signal line E2, to the pump P1 and also transmitted, via the signal line E4, to the pump P2, thereby suspending the operation of these pumps P1 and P2. When it is found from this comparison that a predetermined concentration and a predetermined liquid quantity are not yet attained, the information thereof is transmitted, via the signal line E2, to the pump P1 and also transmitted, via the signal line E4, to the pump P2, thereby performing the feed-back control for operating these pumps P1 and P2 until a predetermined concentration and a predetermined liquid quantity can be attained.

Incidentally, the chemical liquid tanks T1 and T2 are also provided with the monitoring devices M1 and M2, respectively. When liquid quantity is found insufficient, a signal is transmitted from these monitoring devices M1 and M2, via the signal lines E1 and E3, to the control section C1, enabling the control section C1 to emit warning.

When it is desired to employ an aqueous solution containing at least one aqueous solution selected from aqueous solution A, aqueous solution B and aqueous solution C among the aforementioned group of aqueous solutions, a solution containing an acid such as sulfuric acid may be filled in the chemical liquid tank T2 and an aqueous solution or a solid matter containing other compounds may be accommodated in the chemical liquid tank T1. In this case, the adjustment of the concentration and liquid quantity of the aqueous solution in the mixing tank T3 can be controlled in the same manner as described above. Further, the concentration and liquid quantity of the aqueous solution may be controlled by feeding pure water from a third chemical tank (not shown) to the mixing tank T3.

{Contacting Step (First Step): S1}

A tank which is designed to be filled with an aqueous solution for eluting Ru through the contact thereof with a solid component B1 containing Ru, i.e. the Ru elution tank T4 is accommodated with the solid component B1 in advance. Then, using the pump P3, an aqueous solution containing formic acid and preliminarily accommodated in the aforementioned mixing tank T3 is fed, via the pipeline L4, to the Ru elution tank T4. By doing so, the aqueous solution containing formic acid is enabled to contact with the solid component B1 containing Ru, thereby creating a Ru compound.

{Elution Step (Second Step): S2}

This Ru compound is enabled to selectively elute into the aqueous solution containing formic acid. In order to promote the elution of Ru, the aqueous solution containing formic acid may be heated with a heater H1. Although not shown, the employment of a stirrer is also effective in promoting the elution of Ru.

By the monitoring device M4, the Ru elution tank T4 is enabled to receive information regarding the pH, temperature, electric conductivity, the composition of aqueous solution, liquid quantity, etc. The information thus received is transmitted, via the signal line E8, to the control section C1. In the interior of the control section C1, these information is compared with the values of data base which have been stored therein in advance, thereby executing the feed-back control. The temperature can be controlled by ON/OFF control of the heater H1. The pH, electric conductivity and the composition of aqueous solution can be optionally selected if needed. The electric conductivity is caused to change as the elution of Ru from the solid component B1 containing Ru is increased. By obtaining this information, it is possible to know the moment where the changes of electric conductivity can no longer be observed substantially. This moment can be judged by the control section C1 as being the finishing point of the second step.

(Filtration Step: S3)

After the aqueous solution containing formic acid is enabled to contact with the solid component B1 containing Ru for a predetermined period of time and the finishing point of the second step has been determined, the signal thereof is transmitted from the control section C1, via the signal line E9, to the valves V1 and V2, thereby opening the valves V1 and V2. The aqueous solution containing formic acid and containing selectively eluted Ru is transferred, via the pipeline L5, to the Ru-recovering tank T5 and stored therein. The solid component B1 containing Ru is permitted to remain as an insoluble solid component 4. As the filter F1, it is possible to employ a filter comprising a mesh-like fluroresin sheet which is overlayed on a vinyl chloride board having a plurality of holes for example.

(Oxidizing Agent-Contacting Step: S5)

The solid component B1 containing Ru and being left as the insoluble solid component 4 is once caused to contact with an oxidizing agent. For example, a signal is transmitted from the control section C1, via the signal line E14, to the valve V2 to close the valve V2. Another signal is transmitted from the control section C1, via the signal line E13, to the valve V3 to open the valve V3. An oxygen gas containing an oxidizing agent is fed from a gas supply source T6, via the pipeline L7, to the insoluble solid component B1.

By removing a liquid (Ru-eluting aqueous solution) containing organic materials from the insoluble solid component B1, the Ru that has been failed to elute in the first step of selectively eluting the Ru compound can be turned into a state in which Ru can be further eluted. Thereafter, the Ru can be eluted by conducting again the oxidizing agent-contacting step S1.

By repeating the operations of the contacting step S1, the eluting step S2, the filtration step S3 and the oxidizing agent-contacting step S5 in this manner, it is possible to recover most of the Ru from the insoluble solid component B1 containing Ru.

When noble metals such as Pt is contained in the insoluble solid component 4, Pt may be separately recovered.

(Step of Recovering Ru as a Solid Matter: S4)

The Ru-recovering tank T5 may be equipped with electrode plates A1 and A2. By adjusting the electric potential of the electrode plates A1 and A2 in accordance with a signal that has been transmitted thereto, via the signal lines E11 and E12, from the control section C1, the Ru contained in the aqueous solution containing formic acid can be recovered as a solid matter at the electrode plate A1 or at the electrode plate A2. In this case, the control section C1 is preferably constructed to have the function of potentiostat.

Using the monitoring device M5, the composition of the aqueous solution containing formic acid is observed and the result obtained can be transmitted, through the signal line E12, to the control section C1. By doing so, the control section C1 judges that Ru has been recovered and the application of a voltage to the electrode plates A1 and A2 is controlled by feed-back, thereby making it possible to judge the finishing time of the fourth step for recovering Ru as a solid matter. The observation of the composition can be performed by the electric conductivity for example.

The aqueous solution containing formic acid after the recovering of Ru as a solid matter can be transferred to a post-treatment step through the pipeline L6.

Incidentally, FIG. 2 illustrates one of the working examples of the embodiment and hence should not be construed as limiting the present invention.

### Example 1

As the solid component 1 containing Ru, 11.0 g of the anode catalyst for use in a direct methanol type fuel cell (TEC81E81; Tanaka Kikinzoku Kogyo K.K.) was employed. To this anode catalyst was added 100 mL of aqueous solution containing 50 wt % formic acid as an Ru-eluting aqueous solution 2 and then heated for two hours at a temperature of 70° C. This Ru-eluting aqueous solution 2 was then cooled to room temperature and insoluble solid component 4 was removed through filtration. The concentration of the filtrate 5 was determined by emission spectrochemical analysis using radiofrequency inductively coupled plasma (hereinafter referred to as ICP). From the concentration thus obtained, the quantity eluted of Pt and Ru was respectively calculated.

### Example 2

As the solid component 1 containing Ru, 11.0 g of the anode catalyst for use in a fuel cell (TEC81E81; Tanaka Noble Metals Industries) was employed. To this anode catalyst were added 99 mL of 32 wt % sulfuric acid and 1 mL of methanol as an Ru-eluting aqueous solution 2 and then heated for two hours at a temperature of 70° C. This Ru-eluting aqueous solution 2 was then cooled to room temperature and insoluble solid component 4 was removed through filtration. The concentration of the filtrate 5 was determined by ICP emission spectrochemical analysis. From the concentration thus obtained, the quantity eluted of Pt and Ru was respectively calculated.

### Example 3

As the solid component 1 containing Ru, 11.0 g of the anode catalyst for use in a fuel cell (TEC81E81; Tanaka Noble Metals Industries) was employed. To this anode catalyst were added 95 mL of 32 wt % sulfuric acid and 5 mL of 1-propanol as an Ru-eluting aqueous solution 2 and then heated for two hours at a temperature of 70° C. This Ru-eluting aqueous solution 2 was then cooled to room temperature and insoluble solid component 4 was removed through filtration. The concentration of the filtrate 5 was determined by ICP emission spectrochemical analysis. From the concentration thus obtained, the quantity eluted of Pt and Ru was respectively calculated.

### Comparative Example 1

As the solid component 1 containing Ru, 20.0 mg of the anode catalyst for use in a fuel cell (TEC81E81; Tanaka Noble Metals Industries) was employed. To this anode catalyst were added 20 mL of aqua regia in place of the Ru-eluting aqueous solution 2 and then heated for two hours at a temperature of 160° C. This aqua regia was then cooled to room temperature and diluted with pure water and then insoluble solid component was removed through filtration. The concentration of the filtrate 5 was determined by ICP emission spectrochemical analysis. From the concentration thus obtained, the quantity eluted of Pt and Ru was respectively calculated. The results obtained are shown in Table 1. In the case of using aqua regia, although the rate of elution was large, Pt was more liable to elute as compared with Ru and the selectivity of the elution of Ru was not recognized.

### Comparative Example 2

The solid component 1 containing Ru was treated in the same manner as in the case of Comparative Example 1 except that 32 wt % sulfuric acid was employed in place of aqua regia. In the employment of sulfuric acid, it was almost impossible to elute Pt and Ru and it was impossible to selectively elute Ru.

### Example 4

Using the solution of Example 2 and Pt as an electrode, the electrolytic reduction was performed to recover Ru. The reduction treatment was performed for two hours at a reduction potential of 0.1V (vs RHE). The recover ratio of Ru was about 95 wt %. The recover ratio of Ru as well as the recover ratio of Pt represents a parameter indicating wt % that had been recovered as a solid matter out of the quantity of Ru and Pt contained in the eluting aqueous solution.

### Example 5

Spent MEA having the following construction was employed as a solid component 1 containing Ru.

Anode: 3.5 mg in PtRu loading
2.0 mg in Nafion (trademark) loading

Cathode: 2.0 mg in PtRu loading
0.5 mg in Nafion (trademark) loading

Electrolytic membrane: Nafion 117 (trademark)

Area of electrodes: 12 cm²

This MEA was placed in a separable flask equipped with a reflux condenser and a stirrer and then 80 mL of 32 wt % sulfuric acid solution and 20 mL of methanol were poured as an Ru-eluting aqueous solution into the flask. After being heated up to the reflux temperature, the reaction was allowed to take place for 8 hours at the reflux temperature. Thereafter, the reaction mixture was cooled to room temperature and subjected to filtration. The concentration of the filtrate 5 was determined by ICP emission spectrochemical analysis. From the concentration thus obtained, the quantity eluted of Pt and Ru was respectively calculated.

Further, the filtrate 5 was subjected to electrolytic reduction in the same manner as described in Example 4, thereby confirming the recovering of Ru. The recovery (recovering ratio) was about 95 wt %.

### Example 6

As the solid component 1 containing Ru, 11.0 g of the anode catalyst for use in a direct methanol type fuel cell (TEC81E81; Tanaka Noble Metals Industries) was employed. To this anode catalyst was added 100 mL of aqueous solution containing 50 wt % formic acid as an Ru-eluting aqueous solution and then heated for 24 hours at a temperature of 70° C. This reaction liquid was then cooled to room temperature and insoluble solid component 4 was removed through filtration.

To this insoluble solid component 4 which was once subjected to the filtration, the same procedures as described above were repeated one more time. Then the concentration of the filtrate 5 was determined by ICP emission spectrochemical analysis. From the concentration thus obtained, the quantity eluted of Pt and Ru was respectively calculated. The results are shown in Table 1. This filtrate was subjected to electrolytic reduction in the same manner as described in Example 4 except that the treating time was changed to 24 hours, thereby confirming the recovering of Ru. The recovery was about 95 wt %.

Subsequently, to this insoluble solid component 4 was added 100 mL of aqua regia (25 mL of nitric acid (70 wt %)+75 mL of hydrochloric acid (36 wt %)) as Pt-recovering aqueous solution and then heated for four hours at a temperature of 160° C. This aqua regia was then allowed to cool to room temperature and then the insoluble solid component 14 was removed through filtration. The concentration of the filtrate 15 was determined by ICP emission spectrochemical analysis. From the concentration thus obtained, the quantity eluted of Pt was calculated, finding that the ratio of elution was 99 wt % or more.

This solution 15 was subjected to electrolytic reduction by the employment of Pt as an electrode and the employment of carbon as a counter electrode, thereby performing the recover of Pt. The recovery of Pt was about 95 wt %.

### Example 7

The treatment of the solid component 1 containing Ru was performed in the same manner as described in Example 1 except that the step of heating for two hours at a temperature of 70° C. in Example 1 was changed to the heating for 24 hours at room temperature (25° C.). Subsequently, the insoluble solid component 4 was removed through filtration. The concentration of the filtrate was determined by ICP emission spectrochemical analysis. From the concentration thus obtained, the quantity eluted of Pt and Ru was calculated respectively.

### Example 8

The treatment of the solid component 1 containing Ru was performed in the same manner as described in Example 3 except that 1-propanol was changed to ethanol. Subsequently, the insoluble solid component 4 was removed through filtration. The concentration of the filtrate 5 was determined by ICP emission spectrochemical analysis. From the concentration thus obtained, the quantity eluted of Pt and Ru was calculated respectively.

From the results obtained in Examples 1, 3 and 8, it was confirmed that when aqueous solution containing alcohols and sulfuric acid was employed as an Ru-eluting aqueous solution, it was possible to selectively elute Ru. In view of these results, it can be assumed that it is possible to obtain almost the same effects even when alcohols of general type are employed.

### Example 9

The treatment of the solid component 1 containing Ru was performed in the same manner as described in Example 3 except that 1-propanol was changed to aldehyde. Subsequently, the insoluble solid component 4 was removed through filtration. The concentration of the filtrate 5 was determined by ICP emission spectrochemical analysis. From the concentration thus obtained, the quantity eluted of Pt and Ru was calculated respectively.

### Example 10

The treatment of the solid component 1 containing Ru was performed in the same manner as described in Example 3 except that 1-propanol was changed to hydroxyaldehyde. Subsequently, the insoluble solid component 4 was removed through filtration. The concentration of the filtrate 5 was determined by ICP emission spectrochemical analysis. From the concentration thus obtained, the quantity eluted of Pt and Ru was calculated respectively.

### Example 11

The treatment of the solid component 1 containing Ru was performed in the same manner as described in Example 3 except that 1-propanol was changed to glyoxal. Subsequently, the insoluble solid component 4 was removed through filtration. The concentration of the filtrate 5 was determined by ICP emission spectrochemical analysis. From the concentration thus obtained, the quantity eluted of Pt and Ru was calculated respectively.

From the results obtained in Examples 9, 10 and 11, it was confirmed that when aqueous solution containing aldehydes and sulfuric acid was employed as an Ru-eluting aqueous solution, it was possible to selectively elute Ru. In view of these results, it can be assumed that it is possible to obtain almost the same effects even when aldehydes of general type are employed.

### Example 12

The treatment of the solid component 1 containing Ru was performed in the same manner as described in Example 3 except that 5.0 mL of 1-propanol was replaced by 2.5 mL of 1-propanol and 2.5 mL of formic acid. Subsequently, the insoluble solid component 4 was removed through filtration. The concentration of the filtrate 5 was determined by ICP emission spectrochemical analysis. From the concentration thus obtained, the quantity eluted of Pt and Ru was calculated respectively.

### Example 13

The treatment of the solid component 1 containing Ru was performed in the same manner as described in Example 3 except that sulfuric acid was replaced by acetic acid. Subsequently, the insoluble solid component 4 was removed through filtration. The concentration of the filtrate 5 was determined by ICP emission spectrochemical analysis. From the concentration thus obtained, the quantity eluted of Pt and Ru was calculated respectively.

### Example 14

The treatment of the solid component 1 containing Ru was performed in the same manner as described in Example 3 except that sulfuric acid was replaced by propionic acid. Subsequently, the insoluble solid component 4 was removed through filtration. The concentration of the filtrate 5 was determined by ICP emission spectrochemical analysis. From the concentration thus obtained, the quantity eluted of Pt and Ru was calculated respectively.

### Example 15

The treatment of the solid component 1 containing Ru was performed in the same manner as described in Example 3 except that 5.0 mL of 1-propanol was replaced by 2.5 mL of 1-propanol and 32 wt % sulfuric acid was replaced by 10 mL of 10 wt % Nafion (trademark). Subsequently, the insoluble solid component 4 was removed through filtration. The concentration of the filtrate 5 was determined by ICP emission spectrochemical analysis. From the concentration thus obtained, the quantity eluted of Pt and Ru was calculated respectively.

### Example 16

The treatment of the solid component 1 containing Ru was performed in the same manner as described in Example 3 except that 5.0 mL of 1-propanol was replaced by 10 mL of 45% sucrose. Subsequently, the insoluble solid component 4 was removed through filtration. The concentration of the filtrate 5 was determined by ICP emission spectrochemical analysis. From the concentration thus obtained, the quantity eluted of Pt and Ru was calculated respectively.

### Example 17

The treatment of the solid component 1 containing Ru was performed in the same manner as described in Example 3 except that 5.0 mL of 1-propanol was replaced by 10 mL of 45% maltose. Subsequently, the insoluble solid component 4 was removed through filtration. The concentration of the filtrate 5 was determined by ICP emission spectrochemical analysis. From the concentration thus obtained, the quantity eluted of Pt and Ru was calculated respectively.

### Example 18

The treatment of the solid component 1 containing Ru was performed in the same manner as described in Example 3 except that 5.0 mL of 1-propanol was replaced by 5 g of lactose. Subsequently, the insoluble solid component 4 was removed through filtration. The concentration of the filtrate 5 was determined by ICP emission spectrochemical analysis. From the concentration thus obtained, the quantity eluted of Pt and Ru was calculated respectively.

### Comparative Example 3

The treatment of the solid component 1 containing Ru was performed in the same manner as described in Example 3 except that 5.0 mL of 1-propanol was replaced by 10 mL of 45% trehalose. Subsequently, the insoluble solid component 4 was removed through filtration. The concentration of the filtrate 5 was determined by ICP emission spectrochemical analysis. From the concentration thus obtained, the quantity eluted of Pt and Ru was calculated respectively.

The results of these Examples and Comparative Examples are shown in Table 1. In Table 1, the elution ratio of Ru as well as the elution ratio of Pt represents a parameter indicating wt % that had been eluted in the filtrate out of the quantity of Ru and Pt contained respectively in the anode catalyst.

TABLE 1

| | Solid component | | | | | | | | | Elution | | | |
|---|---|---|---|---|---|---|---|---|---|---|---|---|---|
| | containing Ru | | Aqueous solution | | | | | | | ratio | | Recovery | |
| | | Quantity | Organic | Concentration | Content | Weight | Inorganic | Concentration | Content | (wt %) | | (wt %) | |
| | Source | used (g) | system | (wt %) | (mL) | (g) | system | (wt %) | (mL) | Pt | Ru | Pt | Pu |
| Ex. 1 | a | 1 | Formic acid | 50 | 100 | — | — | — | — | ND | 19 | — | — |
| Ex. 2 | a | 1 | Methanol | Stock solution | 1 | — | Sulfuric | 32 | 99 | <1 | 15 | — | — |
| | | | | | | | acid | | | | | | |
| Ex. 3 | a | 1 | 1-prpanol | Stock solution | 5 | — | Sulfuric | 32 | 95 | <1 | 17 | — | — |
| | | | | | | | acid | | | | | | |
| Comp. | a | 0.02 | — | — | — | — | Aqua | — | 20 | 95 | 66 | — | — |
| Ex. 1 | | | | | | | regia | | | | | | |
| Comp. | a | 0.02 | — | — | — | — | Sulfuric | 32 | 20 | ND | ND | — | — |
| Ex. 2 | | | | | | | acid | | | | | | |
| Ex. 4 | — | — | — | — | — | — | — | — | — | — | — | — | 95 |
| Ex. 5 | b | 12 cm² | Methanol | Stock solution | 20 | — | Sulfuric | 32 | 80 | <1 | 55 | 95 | 95 |
| | | | | | | | acid | | | | | | |
| Ex. 6 | | 1 | Formic acid | 50 | 100 | — | — | — | — | <1 | 99 | — | — |
| Ex. 7 | a | 1 | Formic acid | 50 | 100 | — | — | — | — | <1 | 10 | — | — |
| Ex. 8 | a | 1 | Ethanol | Stock solution | 5 | — | Sulfuric | 32 | 95 | | | — | — |
| | | | | | | | acid | | | | | | |
| Ex. 9 | a | 1 | Acetoaldehyde | Stock solution | 5 | — | Sulfuric | 32 | 95 | | | — | — |
| | | | | | | | acid | | | | | | |
| Ex. 10 | a | 1 | Hydroxaldehyde | Stock solution | 5 | — | Sulfuric | 32 | 95 | | | — | — |
| | | | | | | | acid | | | | | | |
| Ex. 11 | a | 1 | Glyoxal | Stock solution | 5 | — | Sulfuric | 32 | 95 | | | — | — |
| | | | | | | | acid | | | | | | |
| Ex. 12 | a | 1 | 1-prpanol | Stock solution | 5 | — | Sulfuric | 32 | 95 | 0.5 | 15 | — | — |
| | | | | | | | acid | | | | | | |
| Ex. 13 | a | 1 | 1-prpanol | Stock solution | 5 | — | Propionic | 32 | 95 | 0.4 | 16 | — | — |
| | | | | | | | acid | | | | | | |
| Ex. 14 | a | 1 | 1-prpanol | Stock solution | 2.5 | — | Sulfuric | 32 | 95 | 0.5 | 17 | — | — |
| | | | Formic acid | Stock solution | 2.5 | | acid | | | | | | |
| Ex. 15 | a | 1 | 1-prpanol | Stock solution | 2.5 | — | Nafion | 10 | 10 | 0.3 | 17 | — | — |
| Ex. 16 | a | 1 | Sucrose | 45 | 10 | — | Sulfuric | 32 | 95 | 0.4 | 18 | — | — |
| | | | | | | | acid | | | | | | |
| Ex. 17 | a | 1 | Maltose | 45 | 10 | — | Sulfuric | 32 | 95 | 0.5 | 8 | — | — |
| | | | | | | | acid | | | | | | |
| Ex. 18 | a | 1 | Lactose | — | — | 5 | Sulfuric | 32 | 95 | 0.3 | 7 | — | — |
| | | | | | | | acid | | | | | | |

In above Table 1, the source “a” represents an anode catalyst (TEC81E81; Tanaka Noble Metals Industries) and the source “b” represents a spent MEA.

From the results shown in Table 1, it was possible to confirm that when an acidic material and a reducing material (such as sucrose, maltose, lactose) or a material which generates a reducing material in the co-existence of an acid (such as primary alcohols, etc.) were added to a solid component containing Ru, it was possible to selectively elute the Ru. However, in the case of the system where a reducing material was not incorporated or the system where a non-reducing material (trehalose) was incorporated, it was impossible to enable the Ru to selectively elute. In view of these facts, it was possible to generally confirm the effects of selectively eluting Ru that could be obtained as an acidic material and a reducing material (such as sucrose, maltose, lactose) or a material which is capable of generating a reducing material in the co-existence of an acid (such as primary alcohols, etc.) were added to a solid component containing Ru.

### Example 19

As the solid component 1 containing Ru, 0.5 g of the anode catalyst for use in a direct methanol type fuel cell (HiSPEC6000: a carrier-free catalyst; Johnson Mathhey Co., Ltd.) was employed. To this anode catalyst was added 50 mL in total of an aqueous solution containing about 3M sulfuric acid and 0.2M of 1-propanol as an Ru-eluting aqueous solution and then heated for two hours at a temperature of 70° C. As a result, the elution ratio of Ru was 15 wt %.

### Example 20

As the solid component 1 containing Ru, 0.5 g of the anode catalyst for use in a direct methanol type fuel cell (HiSPEC6000: a carrier-free catalyst; Johnson Mathhey Co., Ltd.) was employed. To this anode catalyst was added 50 mL of an Ru-eluting aqueous solution wherein sulfuric acid was adjusted to about 3M and 1-propanol was adjusted to about 0.2M and then heated for two hours at a temperature of 70° C. As a result, the elution ratio of Ru was 15 wt %.

Subsequently, this catalyst was filtered to recover it as an insoluble solid components 4 and exposed to an oxidizing agent (air) for one second or more at room temperature, after which the insoluble solid components 4 was heated again in the aforementioned Ru-eluting aqueous solution. This operation was repeated nine times. As a result, the elution ratio of Ru was increased to 29 wt %.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A recovering method comprising:
contacting a solid component containing Ru with an aqueous solution to create a Ru compound, the aqueous solution being formed of at least one selected from the group consisting of an aqueous solution A comprising an acid and formic acid, alcohols, aldehydes, a compound having a hemiacetal structure or a compound having an acetal structure, an aqueous solution B comprising an acid and a compound which creates, in the coexistence thereof with the acid, formic acid, alcohols, aldehydes, a compound having a hemiacetal structure or a compound having an acetal structure, an aqueous solution C comprising an acid and sugars, an aqueous solution D comprising formic acid, and an aqueous solution E comprising oxalic acid; and
selectively eluting the Ru compound in the aqueous solution.

2. The method according to claim 1, wherein the solid component further comprises Pt.

3. The method according to claim 1, further comprising recovering the Ru compound as a solid matter from the aqueous solution after the Ru compound is selectively eluted in the aqueous solution.

4. The method according to claim 2, further comprising recovering Pt after the Ru compound is selectively eluted in the aqueous solution.

5. The method according to claim 1, wherein the aqueous solution of the Ru compound is performed by heating the aqueous solution.

6. The method according to claim 1, wherein the acid includes at least one selected from the group consisting of sulfuric acid, hydrochloric acid, formic acid, carboxylic acid and an organic acid.

7. The method according to claim 1, further comprising:
contacting the solid component with an oxidizing agent after the Ru compound is selectively eluted in the aqueous solution;
contacting the solid component that has been contacted with the oxidizing agent with an aqueous solution to form a Ru compound, the aqueous solution being formed of at least one selected from the group consisting of an aqueous solution A comprising an acid and formic acid, alcohols, aldehydes, a compound having a hemiacetal structure or a compound having an acetal structure, an aqueous solution B comprising an acid and a compound which creates, in the coexistence thereof with the acid, formic acid, alcohols, aldehydes, a compound having a hemiacetal structure or a compound having an acetal structure, an aqueous solution C comprising an acid and sugars, an aqueous solution D comprising formic acid, and an aqueous solution E comprising oxalic acid; and
selectively eluting the Ru compound in the aqueous solution.

8. The method according to claim 7, further comprising:
contacting the solid component with an oxidizing agent after the Ru compound is selectively eluted in the aqueous solution;
contacting the solid component that has been contacted with the oxidizing agent with an aqueous solution to form a Ru compound, the aqueous solution being formed of at least one selected from the group consisting of an aqueous solution A comprising an acid and formic acid, alcohols, aldehydes, a compound having a hemiacetal structure or a compound having an acetal structure, an aqueous solution B comprising an acid and a compound which creates, in the coexistence thereof with the acid, formic acid, alcohols, aldehydes, a compound having a hemiacetal structure or a compound having an acetal structure, an aqueous solution C comprising an acid and sugars, an aqueous solution D comprising formic acid, and an aqueous solution E comprising oxalic acid; and
selectively eluting the Ru compound in the solution.

9. The method according to claim 7, wherein the oxidizing agent is at least one selected from the group consisting of oxygen, air, ozone and hydrogen peroxide.

10. The method according to claim 7, further comprising removing liquid from a solid component containing the Ru before or after contacting the solid component with an oxidizing agent.

11. The method according to claim 7, further comprising adjusting pH of the aqueous solution containing eluted Ru after the Ru compound is selectively eluted in the aqueous solution, and removing organic materials in the aqueous solution containing eluted Ru.

12. A recovering system which is equipped with a tank for accommodating a solid component containing Ru and an aqueous solution which is designed to be contacted with the solid component and capable of eluting Ru;
wherein the aqueous solution is formed of at least one selected from the group consisting of an aqueous solution A comprising an acid and formic acid, alcohols, aldehydes, a compound having a hemiacetal structure or a compound having an acetal structure, an aqueous solution B comprising an acid and a compound which creates, in the coexistence thereof with the acid, formic acid, alcohols, aldehydes, a compound having a hemiacetal structure or a compound having an acetal structure, an aqueous solution C comprising an acid and sugars, an aqueous solution D comprising formic acid, and an aqueous solution E comprising oxalic acid; and
the system is designed to be executed by a first step of contacting the solid component containing Ru with the aqueous solution to create a Ru compound, and a second step of causing the Ru compound to selectively elute in the aqueous solution.

13. The system according to claim 12, further comprising a third step of recovering the Ru compound as a solid matter from the aqueous solution after the second step.

14. The system according to claim 12, wherein the acid includes at least one selected from the group consisting of sulfuric acid, hydrochloric acid, formic acid, carboxylic acid and an organic acid.

15. The system according to claim 12, further comprising contacting the solid matter of the Ru compound with an oxidizing agent after the second step.
